(19) United States
(12) Patent Application Publication
(10) Pub. No.: US 2009/0020977 A1
(43) Pub. Date: Jan. 22, 2009

(54) SYSTEM FOR ASSISTING WITH STARTING PULLED OR PUSHED CARRIAGES

(75) Inventor: Jean-Marc Baggio, Amneville (FR)

Correspondence Address: CANTOR COLBURN, LLP, 20 Church Street, 22nd Floor, Hartford, CT, 06103, US

(73) Assignee: PH.B INNOVATIONS SARL, Strasbourg (FR)

(21) Appl. No.: 12/161,836

(22) PCT Filed: Jan. 23, 2006
(86) PCT No.: PCT/EP07/50648

§ 371 Date: Jul. 23, 2008

(30) Foreign Application Priority Data
Jan. 23, 2006 (FR) 06/00560

(51) Int. Cl. B60S 9/00

(52) U.S. Cl. 280/151

(57) ABSTRACT

The invention offers a mechanism for assisting with starting and propelling a rolling object (2), pushed or pulled, by a translational action on its manoeuring member (push bar 1). The mechanism is driven by the translational movement of said manoeuring member (1) and turns at least one wheel (4) of said rolling object, via a freewheel system.

### TECHNICAL FIELD OF THE INVENTION

The present invention relates in general to the field of rolling objects, whether pushed or pulled.

### BRIEF SUMMARY OF RELATED ART

One problem which has been only partially solved is that of the effort required to get up to speed, in particular during starting or restarting phases when the effort to be provided is greater than during continuous motion.

There is no simple system which is actuated by the same translational kinematics of the operating member as in normal motion.

### BRIEF SUMMARY OF THE INVENTION

The invention provides a mechanism for assisting in starting and advancing a pushed or pulled rolling object by translational action of the operating member (push bar, drawbar) thereof, characterized in that said mechanism, driven by translation of said operating member, sets at least one wheel of said rolling object in rotational motion by means of a free-wheel system.

When setting a rolling object in motion, it is necessary to overcome the inertia of the moving parts and static friction forces. It may also be necessary to increase its gravitational potential energy if its path is uphill. It is convenient to use the effort applied to the operating member, push bar or drawbar, not for directly moving the object but for causing at least one wheel of said rolling object to turn in order to bring about a lower speed than would be brought about by said member by means of a rod or cable system or any other per se known mechanical transmission means capable of converting translational motion into rotation. Since effort and displacement are inversely proportional, the effort to be applied will then be demultiplied and will obviously result in a smaller displacement of the object relative to the displacement of the control member. Since the stroke of the operating member is inevitably limited by design, said member will be in contact with the rolling object at the end of the relative displacement, but with the advantage of having said object at a non-zero speed of displacement and requiring less effort to continue motion because friction forces are now of the dynamic range, thus weaker, and the variations in kinetic energy are also lower. The normal configuration of the member controlling the object is then regained, which results in the need to provide a free-wheel or disengagement mechanism, such that said wheel can continue to turn freely.

The present invention therefore exploits the effort applied by the user on the operating member to drive the rolling object, for example a trolley, indirectly by means of the mechanism according to the invention during a starting phase, which entails an operating member capable of moving relative to the trolley during this starting phase. The operating member may, for example, comprise a push bar mounted so as to be capable of being translated between an initial position (before starting) and a final position, in which it is immobile relative to the trolley and the force applied to the push bar is transmitted directly to the trolley and permits displacement in conventional manner. The distance between the initial and final positions defines the stroke of the push bar, which may be for example of the order of 20 to 30 cm.

### DESCRIPTION OF THE DRAWINGS

Other distinctive features and characteristics of the invention will be revealed by the detailed description of some advantageous embodiments given below by way of example, with reference to the appended drawing. The latter shows in

FIG. 1 a schematic diagram of a variant of a mechanism according to the invention.

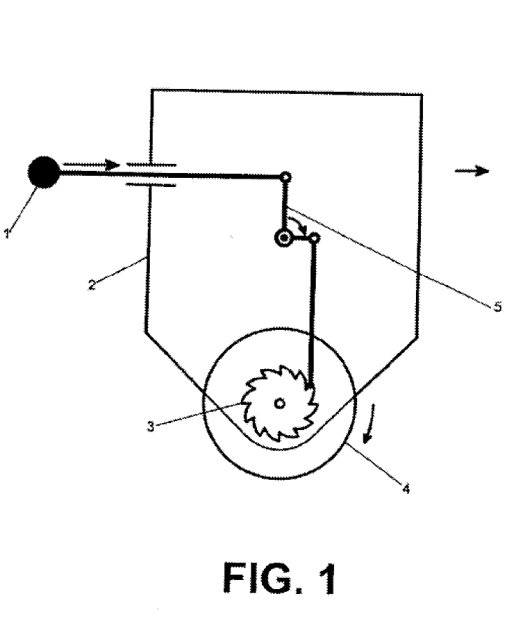

### DETAILED DESCRIPTION OF THE INVENTION

The invention will be better understood in the light of the following detailed description with reference to the appended drawing in which the single FIGURE shows one particular embodiment of the invention. A pushed rolling object 2 is set in motion by an operating member, here a push bar 1. At the outset of the movement, this push bar does not drive the object directly, but causes its wheel 4 to turn by means of a rod linkage 5 and a ratchet wheel 3. The object then begins to move, ideally less quickly than the push bar which, by design, finally comes to a stop and then drives the object directly at its own speed, the wheel and its ratchet wheel then turning freely. A return system, not shown, makes it possible to reposition the mechanism on restarting.

In one particular embodiment of the invention, said at least one wheel is set in rotation progressively. The demultiplication between the displacement of the operating member and of the rolling object is not constant but decreases so as to make best use of the effort applied to said member. It is convenient to start the rolling object with a high level of demultiplication which may then decrease as the rolling object accelerates. This may be achieved with existing mechanical systems such as rod or cable systems, spiral gear systems as described in French patents 0309582 and 0406393, spiral pulley systems as described in the as yet unpublished French patent application 0508771, or by any other per se known variator system.

In one particular embodiment of the invention, the speed of displacement of the rolling object reaches the speed of translation of the operating member, which permits continuous movement at the end of the transitional speeding up phase of the rolling object. This equality of speeds is obtained by carefully calculating the demultiplication of the mechanism and may ideally take the form of the operating member coming into contact with a stationary part of the rolling object, causing the operating member to function identically to an operating member of a conventional rolling object. It will be noted that continuity between the end of the transitional phase and the continuous operating mode is in the spirit of the above-stated patents.

In one particular embodiment of the invention, the operating member may be locked and unlocked as required. The locking and unlocking devices may be embodied by latch, pin or screw systems or any other per se known system and may be operated as required to regain the functionality of a conventional rolling object. This locking operation may also be automatic, in particular at the end of a transitional phase of speeding up before a continuous operating mode.

Likewise, unlocking may also be automatic on each restart or each time effort stops being applied to the operating member. This locking also enables the braking function when the latter is provided by said operating member.

In one particular embodiment of the invention, the mechanism and its free-wheel system must permit backwards motion of the rolling object. This is because it is desirable for the rolling object to be able to move in both directions of motion without any hindrance by the starting assistance device. In the normal direction of motion, this is achieved thanks to the above-mentioned free-wheel system. If backwards motion is desired, it is advisable to add a disengagement means for the mechanism between the operating member and said at least one driven wheel to allow the latter to turn in the opposite direction. This may be achieved by any per se known mechanical release system operated by rotation of a wheel, or by appropriate action on the operating member, or even by an external control.

In one particular embodiment, the mechanism makes it possible to release a parking brake. In the case of rolling objects equipped with a parking brake having the aim of securing them, for example on non-horizontal ground, said brakes must be released before the object is set in motion. It is advantageous to use the starting assistance mechanism to carry out this operation because the latter mechanism is in operation precisely during this starting phase. It is therefore advisable to couple this release device with start of operation of the starting assistance mechanism by any per se known system.

Other embodiments are, of course, possible without going beyond the scope of protection of the present invention.

1. A mechanism for assisting in starting and advancing a pushed or pulled rolling object by translational action of an operating member thereof, wherein said mechanism, driven by translation of said operating member, sets at least one wheel of said rolling object in rotational motion by means of a free-wheel system.

2. The mechanism according to claim 1, wherein said at least one wheel is set in rotation progressively.

3. The mechanism according to claim 1, wherein a speed of displacement of the rolling object reaches a speed of translation of the operating member.

4. The mechanism according to claim 3, wherein the operating member may be locked and unlocked as required.

5. The mechanism according to claim 1, wherein the mechanism and its free-wheel system may allow backwards motion of the rolling object.

6. The mechanism according to claim 1, wherein said mechanism makes it possible to release a parking brake.

7. The mechanism according to claim 1, wherein the operating member may be locked and unlocked as required.
